(19) United States
(12) Patent Application Publication
(10) Pub. No.: US 2010/0018065 A1
(43) Pub. Date: Jan. 28, 2010

(54) SAW, HANDLE AND BLADE

(75) Inventors: Conny Janssson, Vasteras (SE); Mårten Andrén, Spanga (SE); Hans Himbert, Stockholm (SE)

Correspondence Address: BUCHANAN, INGERSOLL & ROONEY PC, POST OFFICE BOX 1404, ALEXANDRIA, VA, 22313-1404, US

(73) Assignee: Kapman AB, Sandviken (SE)

(21) Appl. No.: 12/518,657

(22) PCT Filed: Dec. 11, 2007
(86) PCT No.: PCT/SE07/50973

§ 371 Date: Jun. 11, 2009

Related U.S. Application Data
(60) Provisional application No. 60/874,258, filed on Dec. 12, 2006.

(30) Foreign Application Priority Data
Dec. 11, 2006 (SE) 0602684-3

(51) Int. Cl. B23D 51/01

(52) U.S. Cl. 30/517

(57) ABSTRACT

A saw includes at least one handle and at least one blade, the handle having at least one fastening device having at least one first part in the form of a rotational body, which rotational body can be turned around a first turning axis. The blade is detachable from the handle and has at least one through cut-out extending from an edge of the blade. The first turning axis extends through the at least one cut-out.

The present invention relates to a saw comprising at least one handle and at least one blade, the handle having at least one fastening device having at least one first part in the form of a rotational body, which rotational body can be turned around a first turning axis, the blade being detachable from the handle and having at least one through cut out extending from an edge of the blade. The present invention also relates to a handle for use in a saw and a blade for use in a saw.

### PRIOR ART

U.S. Pat. No. 1,405,928 shows a saw handle having a detachable blade. The combination allows the use of a number of blades for the same handle, including blades of different types for different kinds of work. However, blades of different thickness cannot be used and the stability upon sawing is not at optimum.

### SUMMARY OF THE INVENTION

A first object of the present invention is to provide a saw that, in spite of the blade being detachable, holds the blade more firmly and is more stable upon sawing than hitherto known saws off the corresponding type. A second object of the present invention is to provide a handle for use in such a saw. A third object of the present invention is to provide a blade for use in such a saw.

A fourth object of the present invention is to provide a saw that, by the blade being detachable, allows the fitting of blades of different thicknesses. A fifth object of the present invention is to provide a handle for use in such a saw. A sixth object of the present invention is to provide a blade for use in such a saw.

A seventh object of the present invention is to provide a saw that, by the blade being detachable, allows the fitting of blades upside down in the handle. An eighth object of the present invention is to provide a handle for use in such a saw. A ninth object of the present invention is to provide a blade for use in such a saw.

A tenth object of the present invention is to provide a saw that, by the handle being economically and/or asymmetrically shaped and the blade being detachable, allows sawing with highest comfort and/or with best control and/or with best sawing performance using different types of blades. An eleventh object of the present invention is to provide a handle for use in such a saw. A twelfth object of the present invention is to provide a blade for use in such a saw.

Thus, the invention embraces a saw comprising at least one handle and at least one blade, the handle having at least one fastening device having at least one first part in the form of a rotational body, which rotational body can be turned around a first turning axis, the blade being detachable from the handle and having at least one through cut out extending from an edge of the blade. Said first terming axis extends through said at least one cut out.

Said blade may have at least one side spring tongue that can be brought to spring in a direction substantially perpendicular to the substantial plane of extension of the blade. Said at least one rotational body may be connected with and operated by at least one actuation device of said fastening device.

A second part of said fastening device in the form of an insert may alone comprise at least one first contact surface that abuts against a first side of the blade, at least one second contact surface that abuts against a second side of the blade, and at least one third contact surface that abuts against at least one groove adapted therefor in at least one additional part of said fastening device or in the handle, wherein said first and second contact surfaces may retain and stabilize the blade in the handle. A second part of said fastening device in the form of a first insert may comprise at least one first contact surface that abuts against a first side of the blade, and a third part of said fastening device in the form of a second insert may comprise at least one second contact surface that abuts against a second side of the blade, wherein said first and second contact surfaces may retain and stabilize the blade in the handle.

Said second part of said fastening device may be movable in relation to said handle at assembly and/or disassembly of said blade in said handle with the purpose of facilitating the assembly and/or the disassembly.

At least one of said second and third parts of said fastening device may be movable in relation to said handle at assembly and/or disassembly of said blade in said handle with the purpose of facilitating the assembly and/or the disassembly. Said second part may be movable around and/or in relation to said first turning axis in a first end of said second part and around and/or in relation to a second turning axis in a second end of said second part, wherein said first and second turning axiss may be directed substantially perpendicular to a substantial plane of extension of said blade. Said at least one part of said second and third parts may be movable around and/or in relation to said first turning axis in a first end of said at least one part and around and/or in relation to a second turning axis in a second end of said at least one part, wherein said first and second turning axis may be directed substantially perpendicular to a substantial plane of extension of said blade.

Said first turning axis may be constituted by said at least one rotational body. Said at least one rotational body may comprise at least one finger-like formation, which upon closure of said at least one actuation device in connection with fitting of said blade in said handle co-operates with said at least one cut out in said blade and pulls said blade in a direction toward said handle and in that connection pulls in a part of said blade in place between said first and second contact surfaces of said fastening device, while on the other hand said finger-like formation upon opening of said at least one actuation device in connection with disassembly of said blade in said handle may co-operate with said at least one cut out in said blade and press said blade in a direction away from said handle and in that connection press a part of said blade out of the position between said first and second contact surfaces of said fastening device.

Said second turning axis may consist of at least one shaft. Said at least one shaft may consist of at least one bolt or the like. Said fastening device may have at least one spring, which upon opening of said at least one actuation device in connection with disassembly of said blade in said handle presses said blade in a direction away from said handle. Said at least one spring may be integral with said fastening device. Said at least one rotational body may comprise at least one first stop lip. Said at least one rotational body may comprise at least one second stop lip. Said at least one rotational body may comprise at least one release bulge. Said handle may have at least one first gripping part having a substantial direction of extension that forms an angle of 5-20° in relation to a substantial plane of extension of said blade. Said first turning axis may extend substantially perpendicular to the substantial plane of extension of the blade.

Thus, the invention also embraces a handle for use in a saw according to any one of the preceding claims, which saw comprises at least one handle and at least one blade, the handle having at least one fastening device with at least one first part in the form of a rotational body, which rotational body can be turned around a first turning axis, the blade being detachable from the handle and having at least one through cut out extending from an edge of the blade and said rotational body being intended to co-operate with saw cut out. Said rotational body can be turned at least approx. 90° around said first turning axis.

Said rotational body may be turned at least approx. 180° around said first turning axis. Said at least one rotational body may be connected with and operated by at least one actuation device of said fastening device. Said actuation device may be in the form of an elongate arm that connects to the rotational body in one end of the elongate arm. At least a part of said fastening device may be movable in relation to said first turning axis in a first end of said at least one part and in relation to a second turning axis in the form of at least one shaft in a second end of said at least one part, said first and second turning axes being substantially parallel.

A second part of said fastening device in the form of an insert may alone comprise at least one first contact surface for abutment against a first side of the blade, at least one second contact surface for abutment against a second side of the blade, and at least one third contact surface that abuts against at least one groove adapted therefor in at least one additional part of said fastening device or in the handle, said first and second contact surfaces being intended to retain and stabilize the blade in the handle. A second part of said fastening device in the form of a first insert may comprise at least one first contact surface that abuts against a first side of the blade, and a third part of said fastening device in the form of a second insert may comprise at least one second contact surface that abuts against a second side of the blade, said first and second contact surfaces being intended to retain and stabilize the blade in the handle. Said insert may be movable in relation to the handle at assembly and/or disassembly of the blade in the handle with the purpose of facilitating the assembly and/or the disassembly. At least one of said first and second inserts may be movable in relation to the handle at assembly and/or disassembly of the blade in the handle with the purpose of facilitating the assembly and/or the disassembly.

Said at least one rotational body may comprise at least one finger-like formation, which upon closure of said at least one actuation device in connection with fitting of the blade in the handle is intended to co-operate with said at least one cut out in said blade and pull said blade in a direction toward the handle and in that connection pull in a part of said blade in place between said first and second contact surfaces of said fastening device, while on the other hand said finger-like formation upon opening of said at least one actuation device in connection with disassembly of said blade in the handle may be intended to co-operate with said at least one cut out in said blade and press said blade in a direction away from the handle and in that connection press a part of said blade out of the position between said first and second contact surfaces of said fastening device.

Said at least one shaft may consist of at least one bolt or the like. Said fastening device may have at least one spring, which upon opening of said at least one actuation device in connection with disassembly of said blade in the handle presses said blade in a direction sway from the handle. Said at least one spring may be integral with said fastening device. Said at least one rotational body may comprise at least one first stop lip. Said at least one rotational body may comprise at least one second stop lip. Said at least one rotational body may comprise at least one release bulge. The handle may have at least one first gripping part having a substantial direction of extension that forms an angle of 5-20° in relation to a substantial plane of extension of said blade when the same is fitted in the handle.

Thus, the invention also embraces a blade for use in a saw according to any one of claims 1-20, which saw comprises at least one handle and al least one blade, the handle having at least one fastening device having at least one first part in the form of a rotational body, which rotational body can be turned around a first turning axis, the blade being detachable from the handle and having at least one through cut out extending from an edge of the blade and said cut out being intended to co-operate with said rotational body. Said at least one cut out has at least one first recess having substantially parallel sides.

Said at least one cut out may have at least one second recess having substantially parallel sides. Said at least one cut out may have at least one third recess having substantially parallel sides. The blade may have at least one side spring tongue that can be brought to spring in a direction substantially perpendicular to the substantial plane of extension of the blade. Said side spring tongue may have a substantial direction of extension, in a substantial plane of extension of the blade, that differs from a substantial direction of extension of said first recess by approx. 0-45°, preferably approx. 0-22.5°, and most preferably approx. 10°.

Said at least one cut out may be symmetrical in a substantial plane of extension of the blade and situated in a first end of the blade, wherein the blade may be fittable in two ways and accordingly invertible in the handle. Said at least one cut out may be symmetrical in respect of a straight line parallel to the toothed edge of the blade, wherein the blade may form a first angle with the handle in the substantial plane of extension of the saw if the blade is fitted in a first way in the handle for sawing substantially downwards and a second angle with the handle in the substantial plane of extension of the saw if the blade is fitted in a second way in the handle for sawing substantially upwards, said first and second angles being equally large. Said at least one cut out may be symmetrical in respect of a straight line not parallel to the toothed edge of the blade, wherein the blade may form a first angle with the handle in the substantial plane of extension of the saw if the blade is fitted in a first way in the handle for sawing substantially downwards and a second angle with the handle in the substantial plane of extension of the saw if the blade is fitted in a second way in the handle for sawing substantially upwards, said first and second angles being differently large.

Said at least one cut out may be unsymmetrical in a substantial plane of extension of the blade and situated in a first end of the blade. Said first recess may be positioned closest to a first long side of the blade, said second recess may be positioned closest to a second long side of the blade, and said third recess may be positioned between said first recess and said second recess, wherein said first recess may be intended to co-operate with a finger-like formation of said rotational body. Said side spring tongue may be situated between said first recess and said third recess of the blade.

### LIST OF FIGURES

FIG. 1 shows, in perspective view, a part of a handle and a part of a blade according to the invention before fitting of the blade in the handle.

FIG. 2 shows, in perspective view, the handle and the blade according to FIG. 1 when the fitting of the blade has been commenced, the blade being in contact with a shaft.

FIG. 3 shows, in perspective view, the handle and the blade according to FIG. 1 when the fitting of the blade has proceeded, the blade being in contact with a shaft as well as a rotational body.

FIG. 4 shows, in perspective view, the handle and the blade according to FIG. 1 when the fitting of the blade has proceeded further, the rotational body having been turned a first distance.

FIG. 5 shows, in perspective view, the handle and the blade according to FIG. 1 when the fitting of the blade has proceeded further, the rotational body having been turned a second distance.

FIG. 6 shows, in perspective view, the handle and the blade according

to FIG. 1 when the fitting of the blade has proceeded further, the rotational body having been turned a third distance.

FIG. 7 shows, in perspective view, the handle and the blade according to FIG. 1 when the fitting of the blade has proceeded further, the rotational body having been turned a fourth distance.

FIG. 8 shows, in perspective view, the handle and the blade according to FIG. 1 when the fitting of the blade has proceeded further, the rotational body having been turned a fifth distance.

FIG. 9 shows, in perspective view, the handle and the blade according to FIG. 1 when the fitting of the blade has proceeded further, the rotational body having been turned a sixth distance and the blade being maximally inserted into the handle.

FIG. 10 shows, in perspective view, the handle and the blade according to FIG. 1 when disassembly of the blade has been commenced, the rotational body having been fumed back a distance corresponding to the position in FIG. 7.

FIG. 11 shows, in perspective view, the handle and the blade according to FIG. 1 when the blade is fitted upside down in the handle.

FIG. 12 shows, in perspective view, a detail of the handle and the blade according to FIG. 1 when the blade is maximally inserted into the handle.

FIG. 13 shows, in side view, an alternative embodiment of a handle and a part of a blade according to the invention, the blade being maximally inserted into the handle.

FIG. 14 shows, in side view, the handle and the blade according to FIG. 13, the rotational body having been turned back a distance corresponding to the position in FIG. 7.

FIG. 15 shows, in side view, the handle and the blade according to FIG. 13, wherein the rotational body has been turned back maximally and the blade can be removed.

FIG. 16a shows, in perspective view, an insert for a fastening device fitted on a handle according to the invention.

FIG. 16b shows, in perspective view, the insert according to FIG. 16a as seen from another angle.

FIG. 17a shows, in perspective view, a first part of a rotational body according to the invention.

FIG. 17b shows, in perspective view, the first part according to FIG. 17a as seen from another angle.

FIG. 18a shows, in perspective view, an alternative embodiment of a first part of a rotational body according to the invention.

FIG. 18b shows, in perspective view, the first part according to FIG. 18a as seen from another angle.

FIG. 19a shows, in perspective view, a second part of a rotational body according to the invention.

FIG. 19b shows, in perspective view, the second part according to FIG. 19a as seen from another angle.

FIG. 20 shows, in perspective view, a part of an actuation device, the first part of the rotational body according to FIG. 18a, a first shaft and the second part of the rotational body according to FIG. 19a according to the invention, the parts of the rotational body being shown schematically.

FIG. 21 shows, in perspective view obliquely from above, an alternative embodiment of a handle and a part of a blade according to the invention, the blade being fitted in the handle.

FIG. 22 shows, in perspective view obliquely from behind, the handle and the part of the blade according to FIG. 21.

FIG. 23 shows, in perspective view obliquely from below, the handle and the part of the blade according to FIG. 21 when the handle is held by a user.

FIG. 24 shows, in side view, the handle and the part of the blade according to FIG. 21 when the handle is held by a user who holds the key partly raised.

FIG. 25 shows, in perspective view from the left and in exploded view, an additional alternative embodiment of a handle and a part of a blade according to the invention and in closed position.

FIG. 26 shows, in perspective view from the right and in exploded view, the handle and the part of the blade according to FIG. 25 and in closed position.

FIG. 27 shows, in side view from the right, a part of a rotational body present on the handle according to FIG. 25 and in open position.

FIG. 28 shows, in perspective view from the left, two inserts present in the handle according to FIG. 25.

FIG. 29 shows, in perspective view from the left, the inserts according to FIG. 28.

FIG. 30 shows, in perspective view from the right, the inserts according to FIG. 28.

FIG. 31 shows, in side view, the blade according to FIG. 25.

FIG. 32 shows, in partly sectioned perspective view from the left, an additional alternative embodiment of a part of a handle (half) and a part of a blade according to the invention and in closed position.

FIG. 33 shows, in partly sectioned perspective view from the left, the part of the handle and the part of the blade according to FIG. 32 and in open position.

FIGS. 34a and b show, in perspective views, the handle according to FIG. 32 and without fastening device.

FIGS. 35a, b and c show, in perspective views and in different angles, two inserts present in the handle according to FIG. 32.

FIG. 36 shows, in perspective view from the left and from exploded view, an actuation device present on the handle according to FIG. 32.

FIGS. 37a, b and c show, in perspective views and from different angles, parts included in a rotational body present on the handle according to FIG. 32.

FIG. 38 shows, in perspective view from the left, two shafts present on the handle according to FIG. 32.

FIG. 39 shows, in side view, the blade according to FIG. 32 and the end of the blade for connection to the handle in partial enlargement.

FIG. 40a shows, in side view and in exploded view, parts of a fastening device included in an additional alternative embodiment of a saw according to the invention, the parts being shown in a position that corresponds to an open position.

FIG. 40b shows, in side view, the parts according to FIG. 40a in contact with a blade according to the present embodiment and in open position.

FIG. 40c shows, in side view and in exploded view, the parts according to FIG. 40a, the parts being shown in a position that corresponds to the closed position.

FIG. 40d shows, in side view, the parts according to FIG. 40a in contact with a blade according to the present embodiment and in closed position.

FIG. 40a shows, in perspective view and in exploded view, the parts according to FIG. 40a having a somewhat modified shape and in closed position.

FIG. 41 shows, in side view, the blade according to FIG. 40 having a somewhat modified shape.

### DESCRIPTION OF EMBODIMENTS

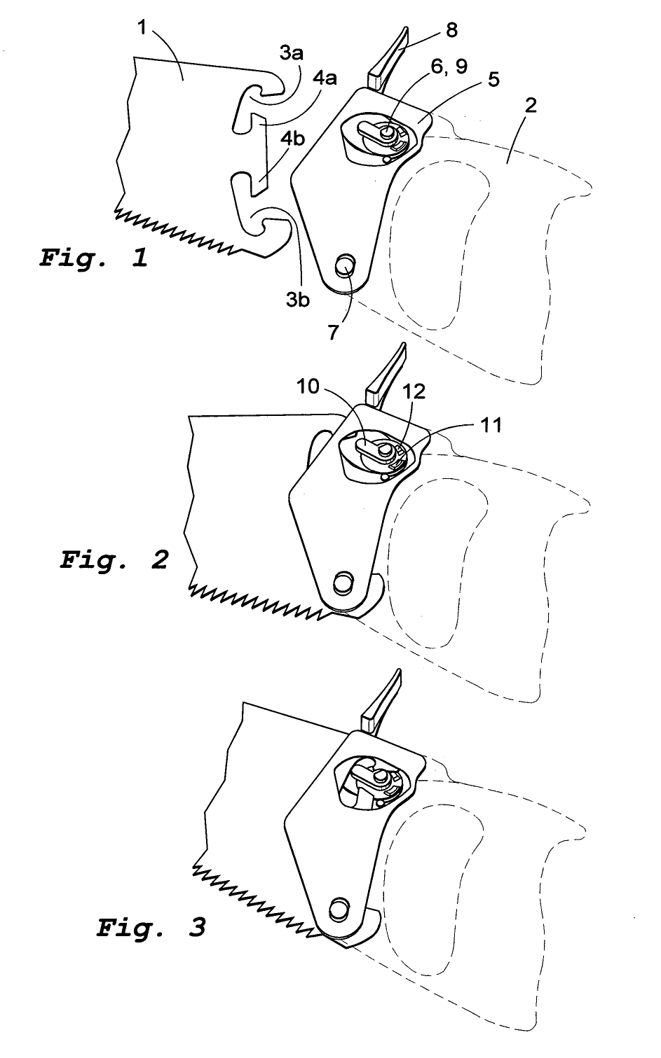

From the FIGS. 1-9, it is seen in sequence how a blade 1 according to the invention is being fitted in a handle 2 according to the invention, consequently a saw according to the invention being obtained. The blade 1 is equipped with a cut out 3 in the end thereof facing the handle, see FIG. 1. The cut out 3 is symmetrically shaped, i.e., an upper half 3a of the cut out 3, such as it is seen in the figure, is a mirror image of a lower half 3b. Furthermore, the blade 1 is equipped with two side spring tongues 4a, 4b, which are characterized in that they, each one, have an ability to spring somewhat laterally out from the blade 1, i.e., spring substantially perpendicular to the substantial plane of extension of the blade 1.

The handle 2 is equipped with a fastening device that, in a first embodiment according to the FIGS. 1-9, comprises two plates 5 situated at a distance from each other, a rotational body 6 and a second shaft 7. The plates 5 are together somewhat movable in relation to the rest of the handle 2 and also in relation to the rest of the fastening device. The rotational body 6 consists of a plurality of co-rotating parts and is operated by an actuation device 8, which via a first shaft 9 is connected to the rest of the rotational body 6. The shafts 7, 9 extend substantially perpendicular to the substantial plane of extension of the fastening device, i.e., the substantial plane of extension of the plates 5. The shafts 7, 9 also extend through the plates 5, the first shaft 9 being mounted with a play in the form of a circumferential opening in a first end of the respective plate 5 (the upper end of the respective plate 5 such as they are shown in the FIGS. 1-9) and the second shaft 7 is mounted with a play in the form of an elongate recess in a second end of the respective plate 5 (the lower end of the respective plate 5 such as they are shown in the FIGS. 1-9).

Upon the fitting, first the second shaft 7 present on the handle 2 is placed in the lower half 3b of the cut out 3 in the blade 1, see FIG. 2, and then the blade 1 is turned in the substantial plane of extension thereof until the rotational body 6 reaches the bottom in the upper half 3a of the cut out 3, see FIG. 3. Next, a locking phase follows, the rotational body 6 being operated by the actuation device 8 in such a way that the free end of the actuation device 6 is pressed in a continuous motion against the handle 2, see the FIGS. 4-9. During this locking process, the blade will also be pulled further closer to the handle since a finger-like formation 10 of the rotational body 6 co-operates with the correspondingly shaped upper part 3a of the cut out 3 in the blade 1.

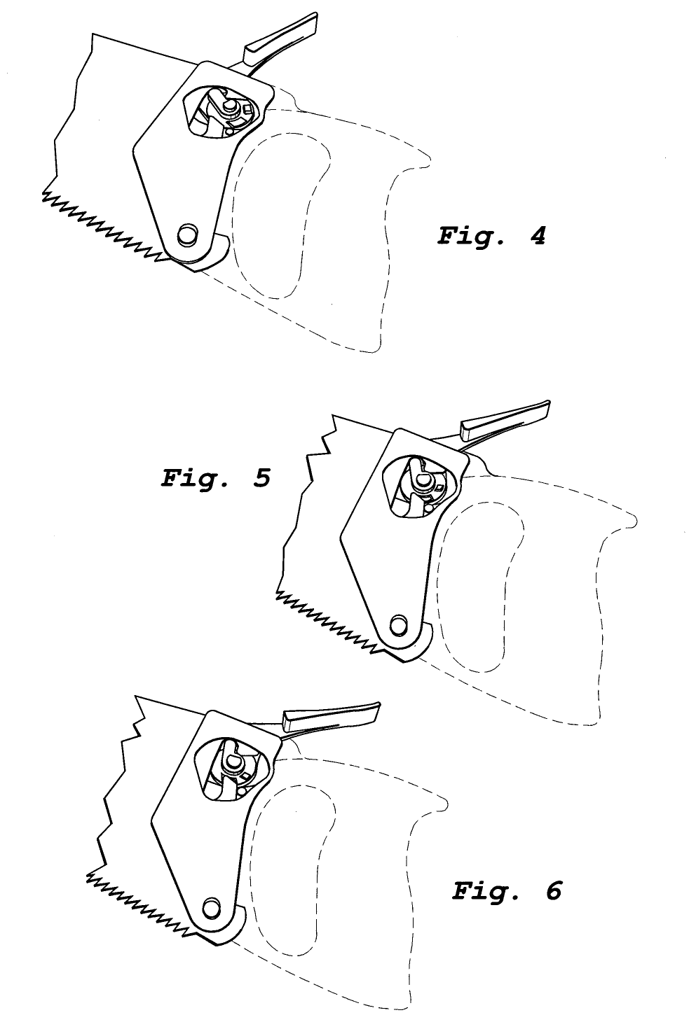

On the rotational body 6, there are also, in the present first embodiment, a bulge 11 and a first stop lip 12. The bulge 11 reaches the side spring tongue 4a in the position of the rotational body 6 that corresponds to FIG. 5, presses the side spring tongue 4a out/up and passes under the same in the position of the rotational body 6 that corresponds to the FIGS. 6-8, and leaves the side spring tongue 4a in the position of the rotational body 6 that corresponds to FIG. 9, in which position the bulge 11 and the stop lip 12 together lock the side spring tongue 4a and thereby the blade in position in the handle. This locked position is seen more clearly in partial enlargement in FIG. 12. The bulge 11 has a length in the peripheral direction (i.e., a direction that is substantially perpendicular to a radius through the first shaft 9, which radius is substantially perpendicular to the substantial direction of extension of the first shaft 9) that approximately corresponds to a distance between the side spring tongue 4a and the rest of the blade 1, i.e., the bulge 11 is accommodated with precision in the space between the side spring tongue 4a and the rest of the blade 1. The edges of the bulge 11 against the side spring tongue 4a and the rest of the blade 1 are chamfered. The edge of the stop lip 12 facing the side spring tongue 4a is, however, not chamfered in order to give the most stable possible locking. One of the plates 5 is equipped with a particular driver 13, which makes that the blade in the locked position presses the plates 5 as close to the handle as possible.

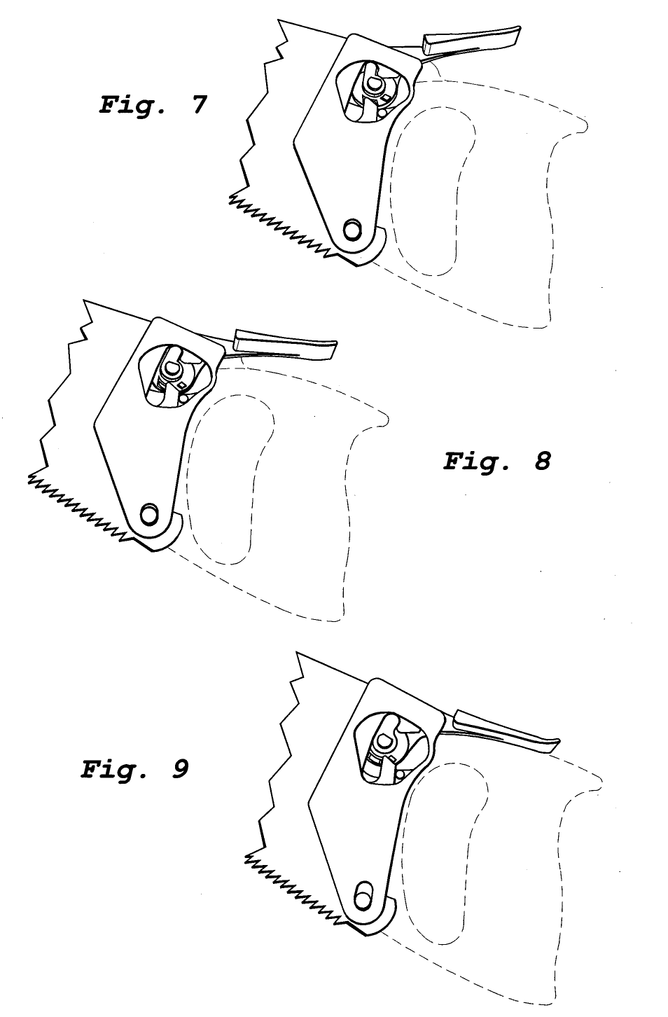

A disassembly of the blade 2 takes place in an analogous way. Additional force is initially required to overcome the resilient force of the side spring tongue 4a when the bulge 11, by the actuation device 8 being spaced apart from the handle 2, is brought to lift the side spring tongue 4a and pass under the same. In FIG. 10, it is seen how the bulge 11 is positioned precisely under the side spring tongue 4a when the actuation device 8 has been spaced apart from the handle 2 into a position that for the fitting phase corresponds to the position according to FIG. 7.

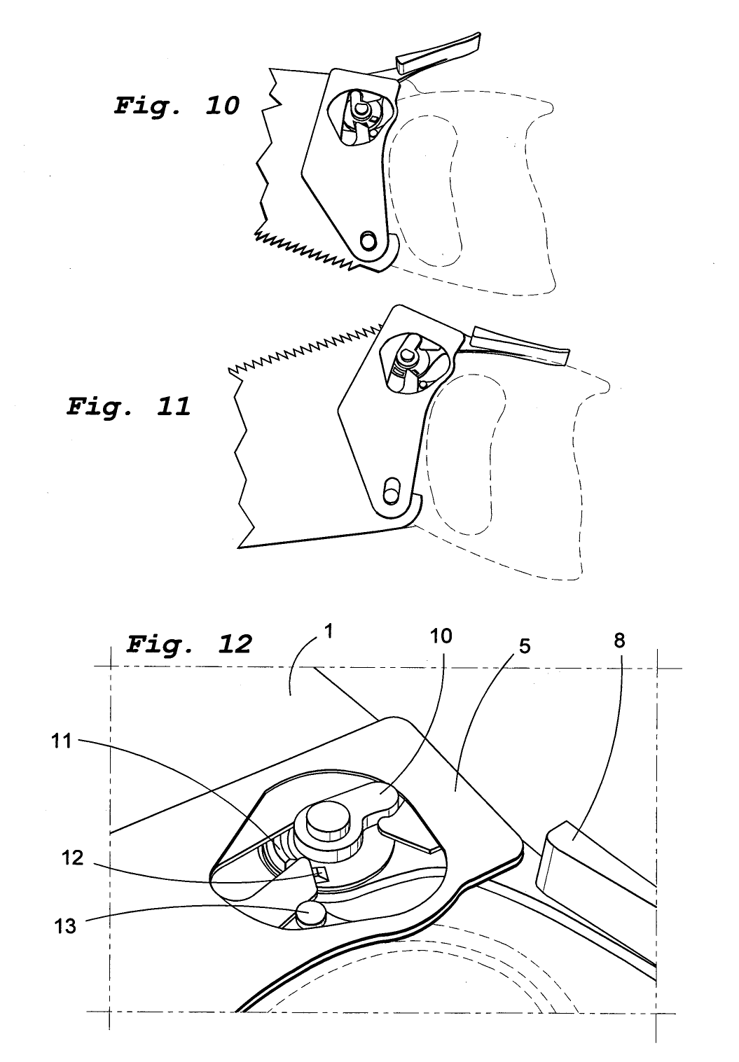

In FIG. 11, it is seen how the blade instead has been fitted upside down in the handle, something that is possible by the fact that the cut out 3 has a symmetrical design. A saw having the blade fitted in this way makes sawing upwards toward, for instance, a ceiling, comfortable.

Blades 1 may be manufactured with different angles between the substantial direction of extension of the cut out 3 in the plane of the blade and the toothed edge of the blade, which blades become suitable for different fields of application. Also the level/position of the cut out 3 on the blade end may be varied, i.e., the cut out 3 may be placed differently far from the toothed edge of the blade.

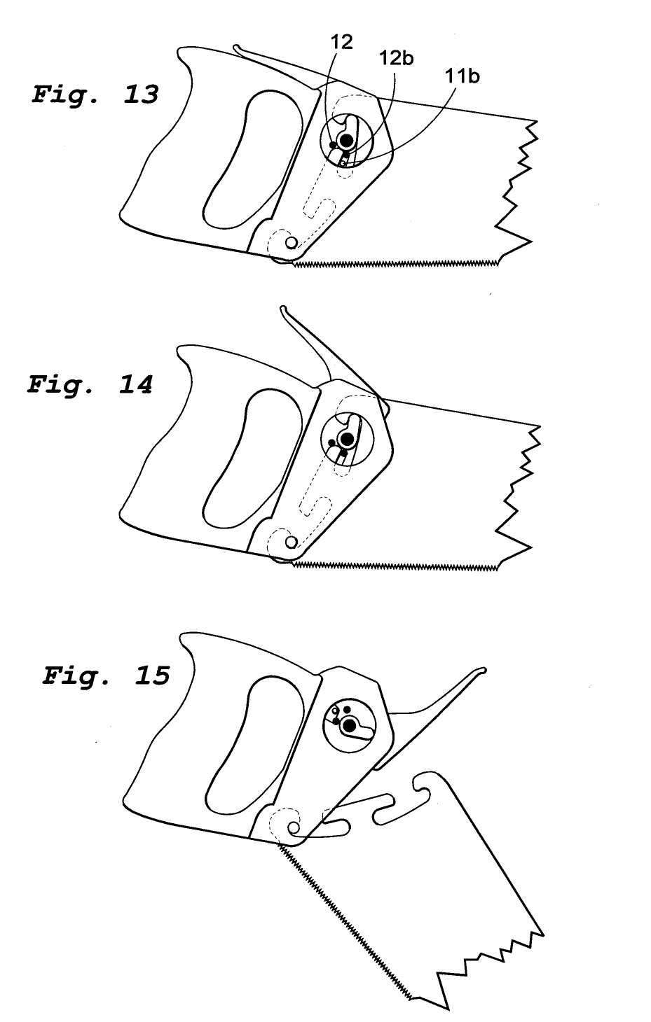

In a second embodiment of the invention, the bulge 11 has been replaced by a second stop lip 12b, the blade 1 in the locked position being entirely Socked between the stop lips 12, 12b, see FIG. 13. In addition to this, a release bulge 11b is present, radially outside the stop lips 12, 12b, that only is used to first lift the side spring tongue 4a so that after that, a stop lip 12b can pass the side spring tongue 4a when disassembling a blade 1. By lifting the actuation device 8 approx. 20°, the release bulge 11b is brought in under the side spring tongue 4a and lifts the same, see FIG. 14, after which further lifting of the actuation device 8 also turns the stop lips 12, 12b and the blade 1 is released, see FIG. 15.

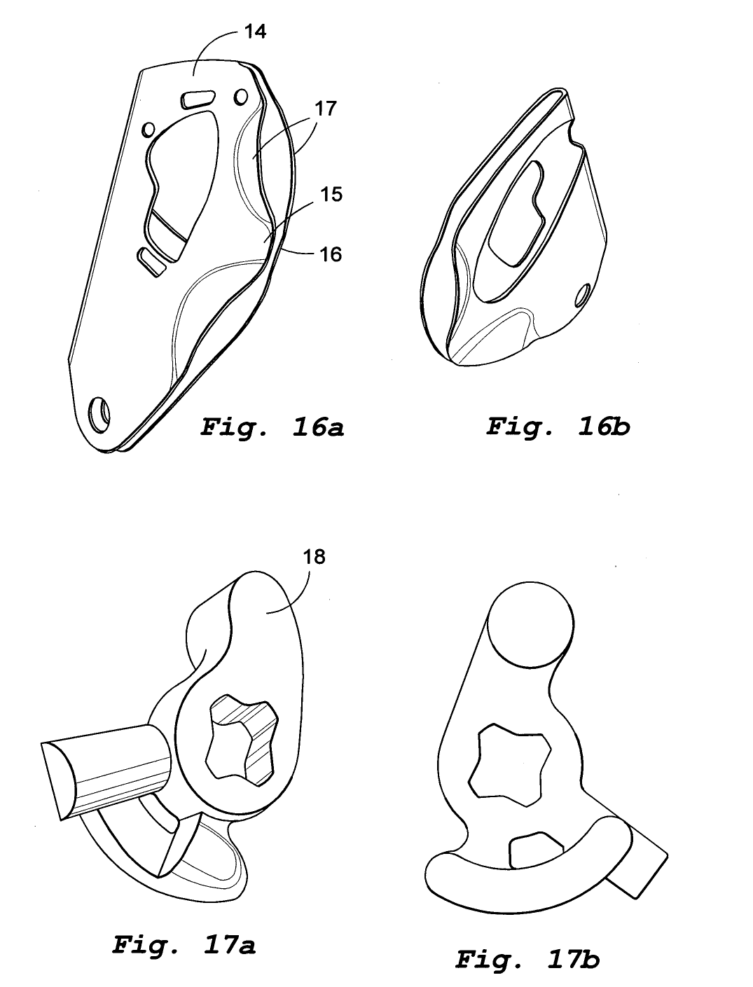

in each one of FIGS. 16a and 16b, an insert 14 is seen manufactured from one and the same piece of plate, which insert may be used, i.e., originally be fitted by the manufacturer of the tool, in the space between the plates 5 to allow the use of saw blades of different thicknesses in one and the same handle, as well as to further improve the stability in the retention of the blade locked in the handle. The insert 14 is manufactured with an inherent initial stress resulting in a first branch 15 always aiming to keep a certain distance to a second branch 16. In the branches 15, 16, there are pressed protuberances 17 that, when the insert 14 is placed in the space between the plates 5, contribute to provide a larger pressure than otherwise from other parts of the insert 14 against a blade 1 that is being fitted and/or is fitted between the branches 15, 16. The insert 14 is also somewhat movable in relation to the rest of the handle 2 and also in relation to the rest of the fastening device, i.e., also in relation to the plates 5.

When the fastening device is maximally open, i.e., the key 8 entirely open, and no blade 1 is fitted in the handle 2, the distance between the branches 15, 16 is maximal. When a blade 1 is being fitted and the actuation device 8 is being closed, i.e., the rotational body 6 is turned in the locking direction, the insert 14 moves further inwards between the plates 5 toward the handle, the pair-wise substantially modifiedly conical shape of the pressed protuberances 17 making that the pressure generated by the plates 5 on the insert 14 increases successively, which in turn resulting in the pressure generated by the branches 15, 16 on the blade 1 also increasing successively. When the actuation device 8 has been entirely closed, i.e., the rotational body 6 has been turned maximally, the blade 1 is retained maximally stably and entirely free of play in the handle 2.

When a blade 1 is being dismounted and the actuation device 8 is being opened, i.e., the rotational body 6 is turned in the unlocking direction, the insert 14 moves outwards between the plates 5 in the direction from the handle, the pair-wise substantially modifiedly conical shape of the pressed protuberances 17 making that the pressure generated by the plates 5 on the insert 14 decreases successively, which in turn resulting in the pressure generated by the branches 15, 16 on the blade 1 also decreasing successively. When the actuation device 8 has been opened entirely, i.e., the rotational body 6 has been turned maximally, the blade 1 can be removed from the handle 2 and the fastening device is maximally open.

The motion of the insert 14 between the plates 5 takes place around and/or in relation to said first turning axis 6 in said first end of the fastening device and around and/or in relation to said second turning axis 7 in said second end of the fastening device.

The insert 14 may be present in constructions according to each one of the described first and second embodiments and is, if so, a part of the fastening device. The insert 14 may also be present in a construction where the plates 5 are lacking and the insert 14 accordingly is fitted in a groove directly in the handle 2, walls in this groove exerting the pressure on the insert 14 that otherwise is exerted by the plates 5 at assembly and/or disassembly of blades 1 in the handle 2.

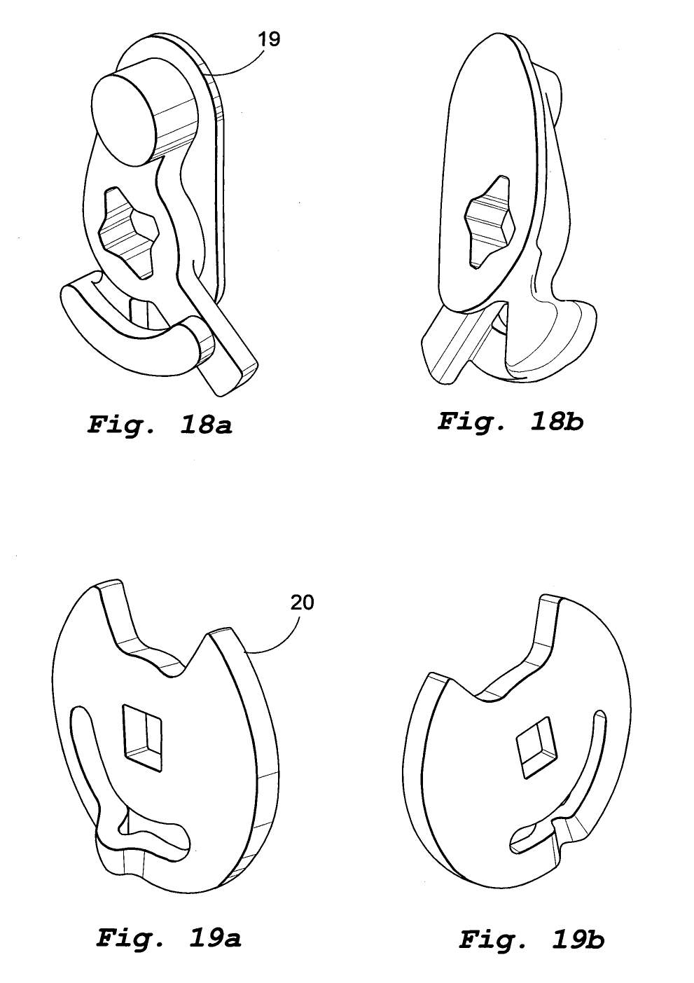

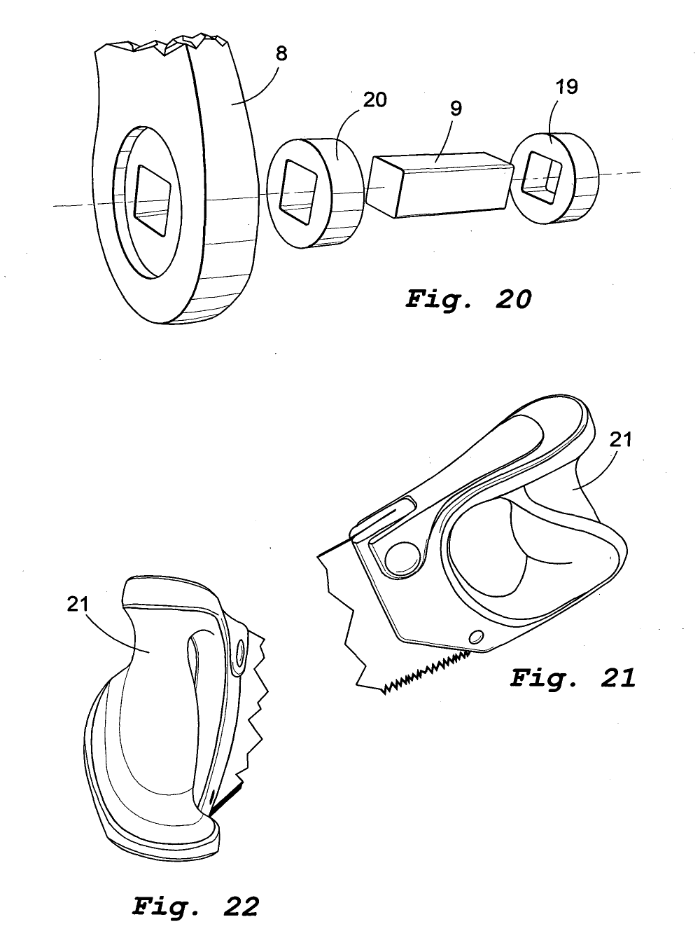

In each one of FIGS. 17a and 17b, a first part 18 of the rotational body 6 according to said first embodiment of the invention is seen. In each one of FIGS. 18a and 18b, a corresponding first part 19 of the rotational body 6 according to said second embodiment of the invention is seen, also a second part 20 of the rotational body 6 being required, see each one of FIGS. 19a and 19b. The way the parts 19, 20 in principle are placed on the first shaft 9 is seen in the exploded view according to FIG. 20, a part of the actuation device 8 also being seen. In FIG. 20, each one of the parts 19 and 20 is represented by a body having, in comparison with the real bodies, a very simplified design. Thus, FIG. 20 relates to said second embodiment—in said first embodiment, the part 20 is accordingly spared and the part 19 is replaced by the part 18 according to the above stated.

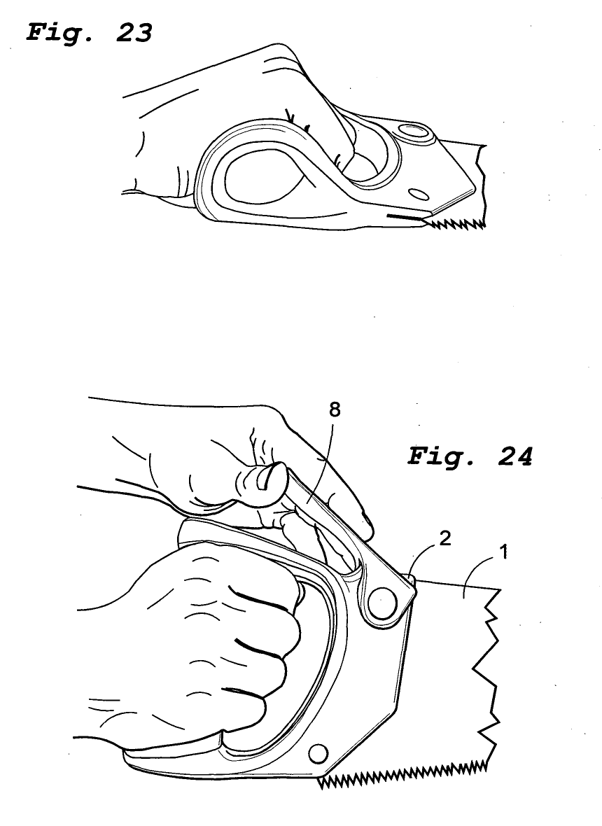

The handle 2 is economically and asymmetrically shaped and has a first gripping part 21 having a substantial direction of extension that forms an angle (“tilt”) of 5-20°, preferably 10-15° and most preferably 12.5° in relation to a substantial plane of extension of the blade 1, sea FIGS. 21-24. Said first gripping part 21 is the one that rests in the palm of the hand when the saw/the handle is gripped. Also all possible angles between a substantial plane of extension of the handle 2 and a substantial plane of extension of the blade 1 may be varied in the production of the handle 2 in order to make sawing as efficient and comfortable as possible. The handle 2 shown in FIGS. 21-24 is made for right-handed persons, but the shape may naturally be mirror-inverted in the manufacture to fit left-handed persons. The size in general may also be varied, such as height, width and so on to fit differently large hands.

Even if the handle 2 in FIGS. 21-24 has no plates 5 and neither no insert 14, but the blade 1 here has been fitted detachably directly in the handle 2, here it should be pointed out that the handle, where appropriate after modification regarding the attachment of the blade on accordance with what has been described above, can be used in combination with any one of the embodiments mentioned in this description. The handle 2 may also be used in combination with fixedly fitted saw blades, by which it is understood permanently fitted saw blades that cannot be dismounted unless the saw is destroyed and/or seriously damaged, wherein design details that intend to facilitate the exchange of blades naturally can be spared and traditional fastening elements of the type screws, bolts, rivets and/or the like be used instead. Glue or the like may also be used. Thus, it is fully possible to conceive a saw comprising at least one handle 2 and at least one blade 1, the blade 1 being permanently fitted in the handle 2, wherein said handle 2 is ergonomically and asymmetrically shaped and has at least one first gripping part 21 having a substantial direction of extension that forms an angle of 5-20°, preferably 10-15° and most preferably 12.5° in relation to a substantial plane of extension of said blade 1.

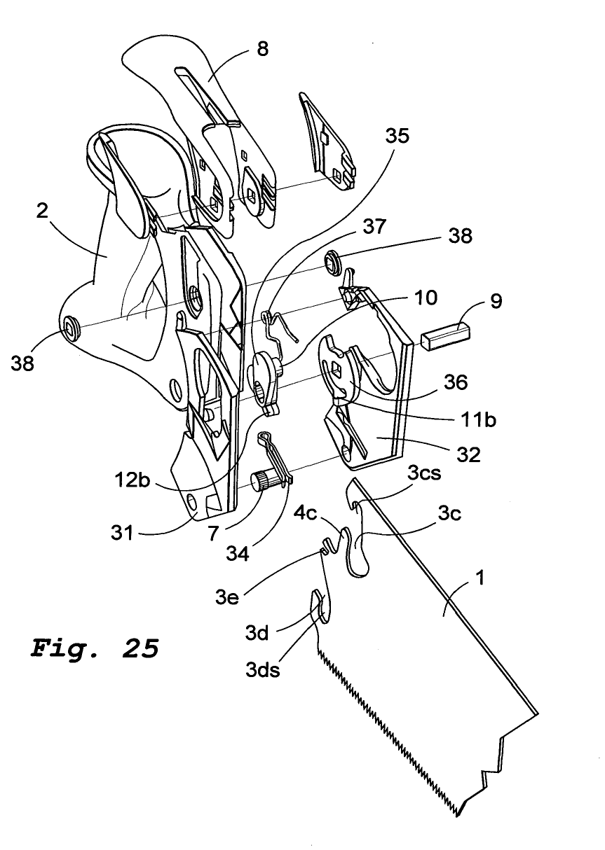

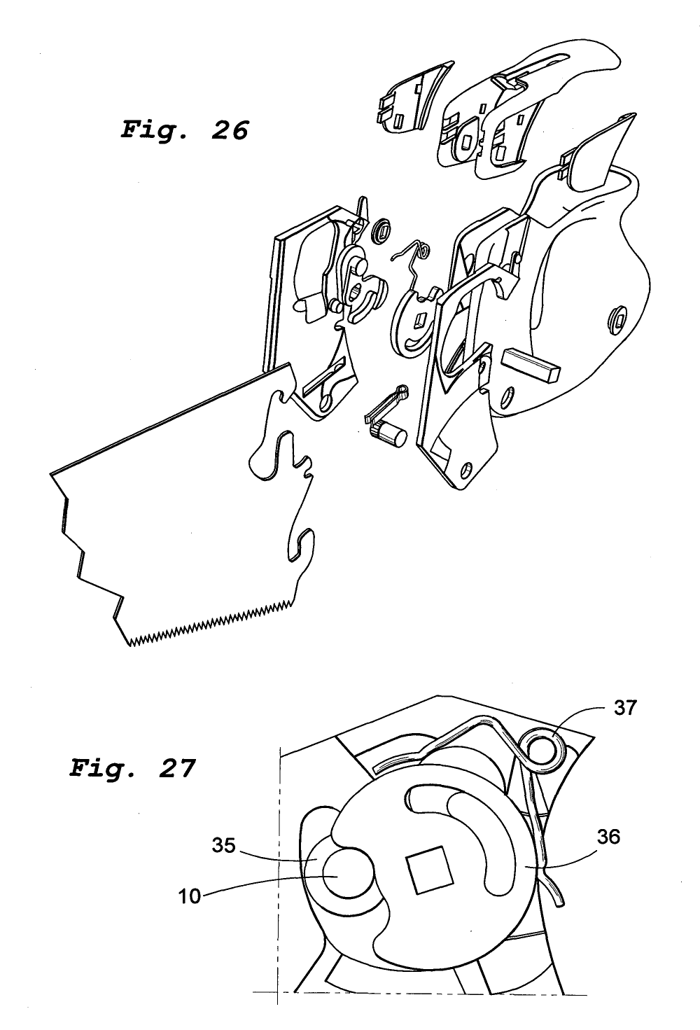

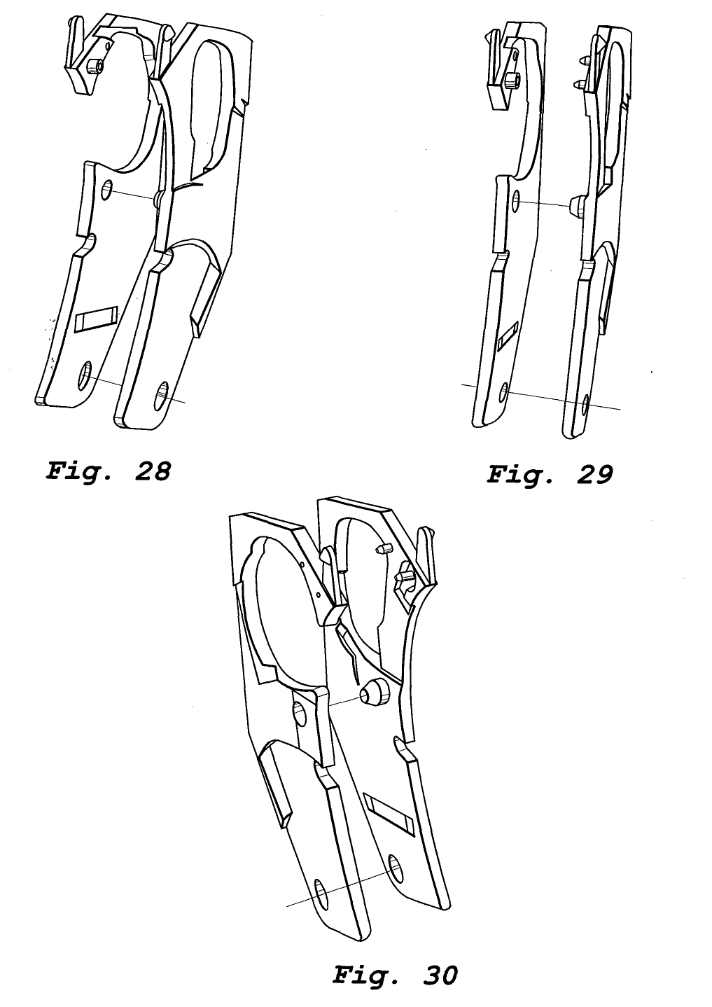

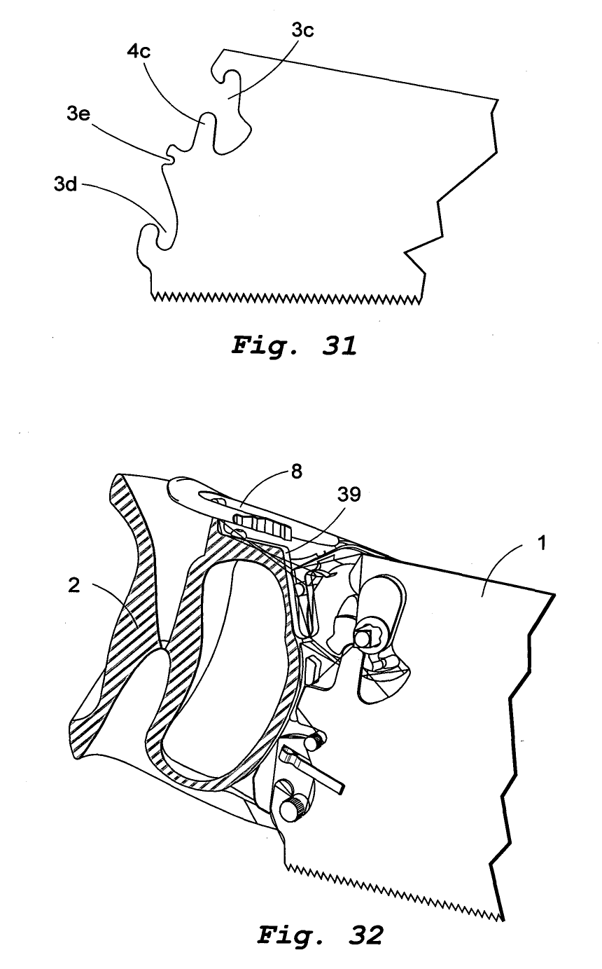

In the FIGS. 25-31, a further embodiment of the saw according to the invention is seen. The handle 2 has a fastening device for the blade 1, which fastening device comprises a rotational body 6, an actuation device 8, a first insert 31, a second insert 32, a second shaft 7, a positioning pin 33 and a first spring 34. The rotational body 6, in turn, comprises an eccentric 35, a washer 36, a shaft 9, a second spring 37 and two bearings 38. The blade 1 has three through cut outs 3c, 3d, 3e extending from an edge of the blade, the first cut out having a first recess 3cs having substantially parallel sides, the second cut out having a second recess 3ds having substantially parallel sides, while the third cut out 3e constitutes a third recess 3es.

The fitting takes place in an analogous way in comparison with the first embodiment of the invention. First, the second shaft 7 of the handle 2 is placed in the second (the lower one in FIG. 25) cut out 3d in the blade 1, after which the blade 1 is turned in the substantial plane of extension thereof until the eccentric 35 reaches the bottom in the first (the upper one in FIG. 25) cut out 3c, see also FIG. 27. During this motion, also the positioning pin 33 fitted directly to the handle 2 or to the inserts 31, 32 is introduced into the third cut out 3e of the blade 1, and the blade is placed between the two branches of the spring 34. Next, a locking phase follows, the rotational body 6 being operated by the actuation device 8 in such a way that the free end of the actuation device 8 is pressed in a continuous motion against the handle 2, involving a turning of the rotational body 6 of at least approx. 90°. During this locking process, the blade will also be pulled further closer to the handle since a finger-like formation 10 of the eccentric 35 co-operates with the correspondingly shaped first cut out 3c in the blade 1. Thus, when the blade 1 has been fitted in the saw, the finger-like formation 10 rests on the eccentric 35 in the first recess 3cs, the second shaft 7 in the second recess 3ds, and the positioning pin 33 in the third recess 3es. The blade 1 also has a side spring tongue 4c.

On the rotational body 6, there are, also in the present embodiment, a first stop lip 12 and a second stop lip 12b on the eccentric 35, tie side spring tongue 4c in the locked position being entirely locked between the stop lips 12, 12b. In addition to this, a release bulge 11b is present on the washer 36, radially outside the stop lips 12, 12b, which release bulge 11b only is used to first lift the side spring tongue 4c so that after that, a stop lip 12b can pass the side spring tongue 4c when disassembling a blade 1. By fitting the actuation device 8 approx. 20°, the release bulge 11b is brought in under the side spring tongue 4c and lifts the same, after which further lifting of the actuation device 8 also turns the stop lips 12, 12b and the blade 1 is released.

The second spring 37 may, by the co-operation with a particular rib on the eccentric 35 in the open position of the actuation device 8, contribute to a parking position of the actuation device 8, involving that the blade 1 has to be pulled out of the handle 2 by hand the last bit upon disassembly. In this way, the risk is minimized that the blade 1 in an undesired moment fells freely out of the handle 2.

The first spring 34 has the general function of exerting a distancing force on the inserts 31, 32 when the same are placed in the handle 2. In this way, the force action from the spring 34 replaces the inherent initial stress that previously has been described in connection with the double-sided insert 14 found in a previously described embodiment of the invention.

When the fastening device is maximally open, i.e., the actuation device 8 entirely open, and no blade 1 is fitted in the handle 2, the distance between the inserts 31, 32 is maximal. When a blade 1 is being fitted and the actuation device 8 is being dosed, i.e., the rotational body 6 is turned in the locking direction, the inserts 31, 32 move further inwards in the handle, their modifiedly conical shape making that the pressure generated by the handle 2 on the inserts 31, 32 increases successively and that thereby the pressure generated by the inserts 31, 32 on the blade 1 increases successively. When the actuation device 8 has been entirely closed, i.e., the rotational body 6 has been turned maximally, the blade 1 is retained maximally stably and entirely free of play in the handle 2.

When a blade 1 is being dismounted and the actuation device 8 is being opened, i.e., the rotational body 6 is turned in the unlocking direction, the inserts 31, 32 move outwards in the handle, the pressure generated by the handle 2 on the inserts 31, 32 decreasing successively, which in turn resulting in the pressure generated by the inserts 31, 32 on the blade 1 also decreasing successively. When the key 8 has been opened entirely, i.e., the rotational body 6 has bean turned maximally, the blade 1 can be removed from the handle 2 and the fastening device is maximally open.

The motion of the inserts 31, 32 in the handle 2 fakes place around and/or in relation to said first turning axis 6 in said first end of the fastening device and around and/or in relation to said second turning axis 7 in said second end of the fastening device.

The thickness of the blade varies between approx. 0.73 mm and approx. 1.15 mm, but is usually approx. 1.0 mm (applies to all embodiments). The side spring tongue 4c has a length of approx. 5 mm-approx. 90 mm, preferably approx. 5 mm-approx. 30 mm, and most preferably approx. 21 mm. It has a width of approx. 7 mm-approx. 12 mm, preferably approx. 9 mm-approx. 10 mm, and most preferably approx. 9.7 mm.

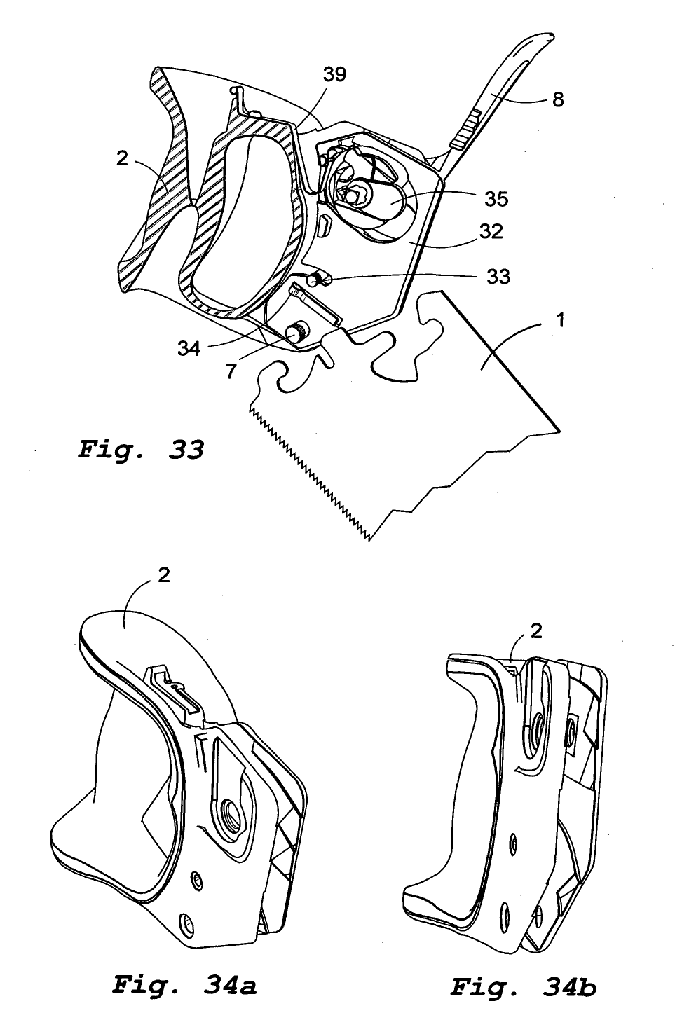

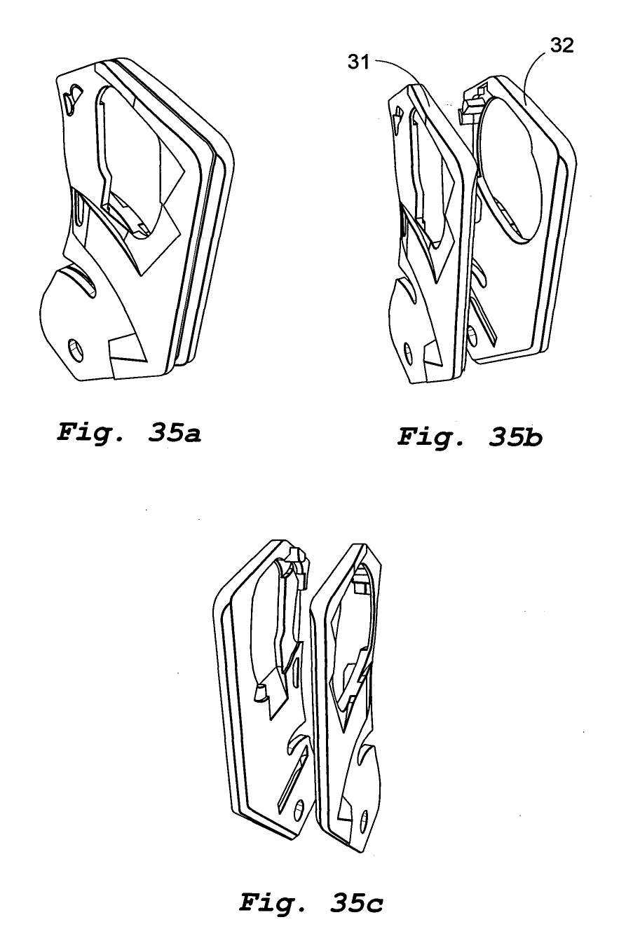

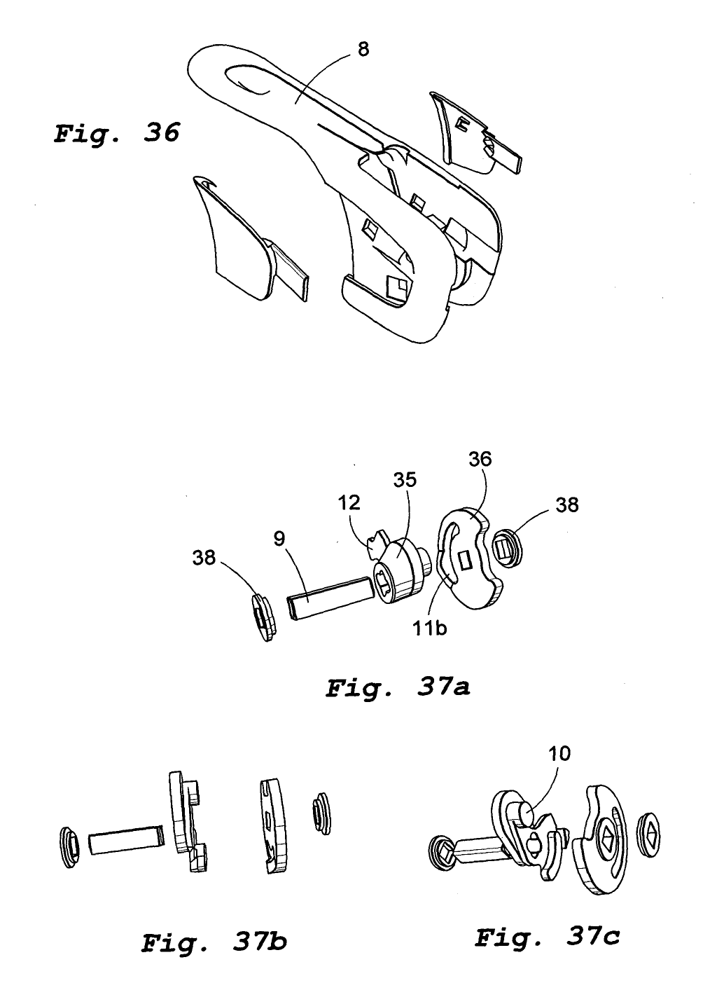

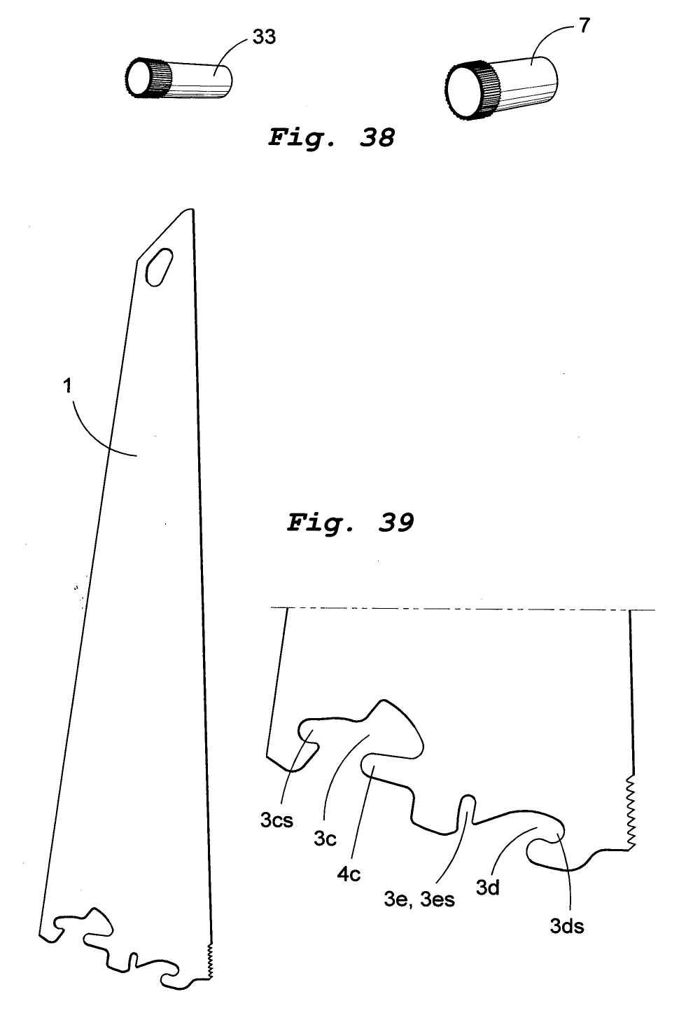

In the FIGS. 32-39, a further embodiment of the saw according to the invention is seen. Here, a spring 39 has another design and partly function than the second spring 37 according to preceding embodiment. An upper/outer end of the spring 39 affords the actuation device 8, when this is in the closed position, i.e., closest to the handle 2, a snap locking. An inner end of the spring 39 affords, like the second spring 37 according to preceding embodiment, the actuation device 8 a parking position by the co-operation with a particular rib on the eccentric 35 in the open position of the actuation device 8, involving that the blade 1 has to be pulled out of the handle 2 by hand the last bit upon disassembly. In this way, the risk is minimized, as mentioned above, that the blade 1 in an undesired moment falls freely out of the handle 2.

The cut out configuration of the blade 1 is also somewhat altered and is most dearly seen in FIG. 39. Also here, the blade 1 has three through cut outs 3c, 3d, 3e extending from an edge of the blade, the first cut out 3c having a first recess 3cs having substantially parallel sides, the second cut out 3d having a second recess 3ds having substantially parallel sides, white the third cut out 3e constituting a third recess 3es. The placement of the third recess 3es and the area above the same in FIG. 39 are, however, somewhat altered in comparison with the preceding embodiment, and therefore, in this case, the third cut out 3e can be regarded as a part of the second cut out 3d.

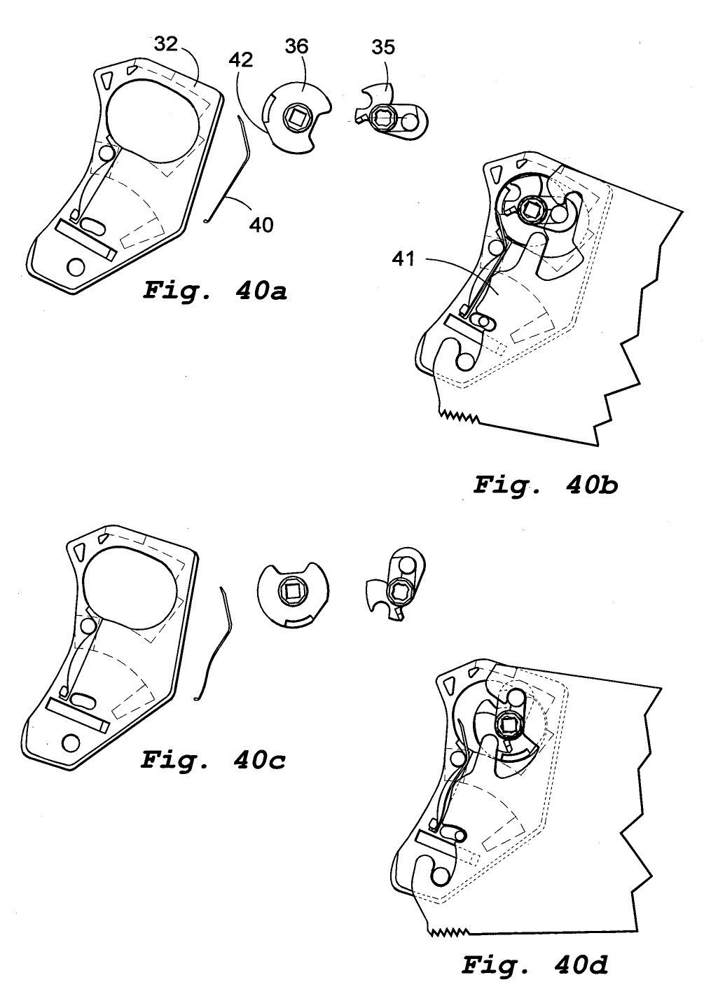

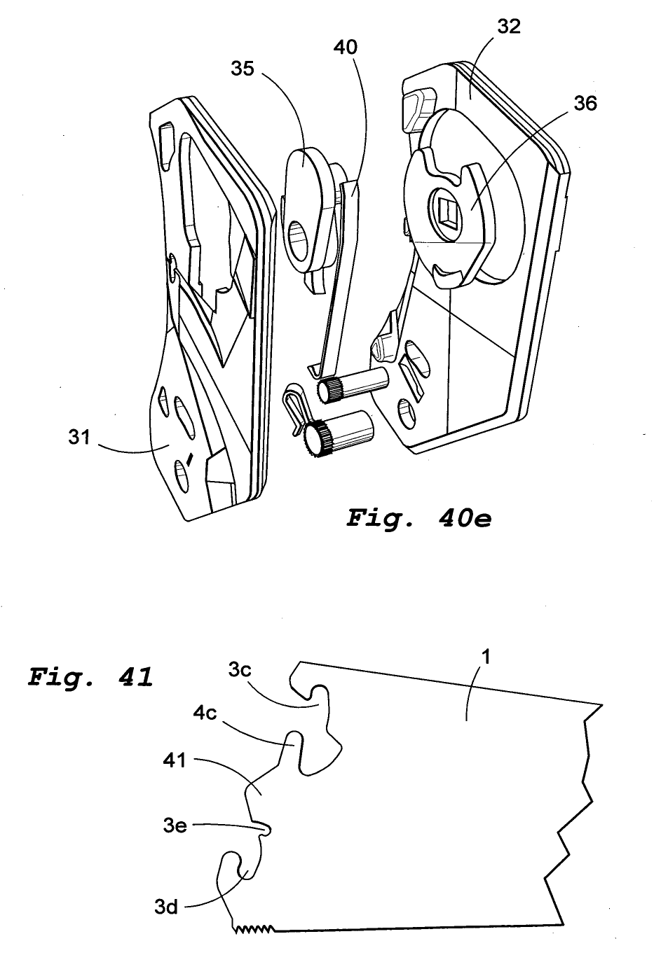

In the FIGS. 40a-e and 41, a further embodiment of the saw according to the invention is seen. Here, a spring 40 has another design and partly function than the spring 39 of preceding embodiment. In FIG. 40a, an insert 32, an eccentric 35, a washer 36 and the spring 40 are seen in exploded view, the shown parts being placed in a position in relation to each other that corresponds to the open position of the actuation device 8. The parts assembled together with a blade 1 are seen in FIG. 40b. When the actuation device 8 is being closed and the blade 1 is being pulled into the handle 2, an intermediate active part 41 of the end of the blade 1 facing the handle 2 will press on the spring 40 and increasingly deform the same. When the spring 40 is being deformed, it will in turn increasingly act on the inserts 31, 32 so that the pressure generated by the inserts 31, 32 on the blade 1 increases. The dosed state is seen in FIGS. 40c-40e, wherein it should be observed that the spring 40 is depicted loaded in FIGS. 40c and 40d and unloaded in FIG. 40e. The spring 40 may, by the co-operation with a particular plane surface 42 of the washer 36, in the open position of the actuation device 8, contribute to a parking position of the actuation device 8, involving that the blade 1 has to be pulled out of the handle 2 by hand the last bit upon disassembly.

The cut out configuration of the blade 1 is also somewhat altered. Also here, the blade 1 has three through cut outs 3c, 3d, 3e extending from an edge of the blade, the first cut out having a first recess 3cs having substantially parallel sides, the second cut out having a second recess 3ds having substantially parallel sides, while the third cut out 3e constituting a third recess 3es. The placement of the third recess 3es and the area above the same are, however, somewhat altered in comparison with the preceding embodiment. Also in this case, the third cut out 3e can be regarded as a part of the second cut out 3d. In FIG. 41, a modification of the blade according to FIGS. 40b and 40d is seen, the active part 41 being more convex in the substantial plane of extension of the blade 1 and accordingly affecting the spring 40 more.

In general, it applies that the first turning axis 6 extends substantially perpendicular to the substantial plane of extension of the blade 1. The blades are of metal and the inserts most often of plastic, but any other expedient known materials are feasible. By the expressions insert (“inlägg”) and insert (“insats”) in this description, the same thing is meant.

The invention is not limited to the embodiments shown here, but may be varied within the scope of the subsequent claims.

1.-48. (canceled)

49. Saw comprising at least one handle and at least one blade, the handle having at least one fastening device with at least one first part in the form of a rotational body, which rotational body can be turned around a first turning axis, the blade being detachable from the handle and having at least one through cut out extending from an edge of the blade, said first turning axis extending through said at least one cut out, a second part of said fastening device being in the form of an insert movable in relation to said handle at assembly and/or disassembly of said blade relative to said handle, said second part being movable around and/or in relation to said first turning axis in a first end of said second part and around and/or in relation to a second turning axis in a second end of said second part.

50. Saw according to claim 49, wherein said blade has at least one side spring tongue that can be brought to spring in a direction substantially perpendicular to a plane of extension of the blade.

51. Saw according to claim 49, wherein said at least one rotational body is connected with and operated by at least one actuation device of said fastening device.

52. Saw according to claim 49, wherein said second part of said fastening device alone comprises at least one first contact surface that abuts against a first side of the blade, at least one second contact surface that abuts against a second side of the blade, and at least one third contact surface that abuts against at least one groove adapted therefor in at least one additional part of said fastening device or in the handle, said first and second contact surfaces retaining and stabilizing the blade in the handle.

53. Saw according to claim 49, wherein said second part of said fastening device comprises at least one first contact surface that abuts against a first side of the blade, and a third part of said fastening device in the form of a second insert comprises at least one second contact surface that abuts against a second side of the blade, said first and second contact surfaces retaining and stabilizing the blade in the handle.

54. Saw according to claim 52, wherein said second part of said fastening device is movable in relation to said handle at assembly and/or disassembly of said blade in said handle with the purpose of facilitating the assembly and/or the disassembly of said blade.

55. Saw according to claim 53, wherein said second and third parts of said fastening device are movable in relation to said handle at assembly and/or disassembly of said blade relative to said handle with the purpose of facilitating the assembly and/or the disassembly of said blade.

56. Saw according to claim 54, wherein said first and second turning axes being directed substantially perpendicular to a plane of extension of said blade.

57. Saw according to claim 55, wherein said second and third parts being movable around and/or in relation to said first turning axis in a first end of said parts respectively and around and/or in relation to a second turning axis in a second end of said parts respectively, said first and second turning axes being directed substantially perpendicular to a plane of extension of said blade.

58. Saw according to claim 56, wherein said first turning axis is constituted by said at least one rotational body.

59. Saw according to claim 58, wherein said at least one rotational body comprises at least one finger-like formation, which upon closure of said at least one actuation device in connection with fitting of said blade in said handle co-operates with said at least one cut out in said blade and pulls said blade in a direction toward said handle to pull in a part of said blade in place between said first and second contact surfaces of said fastening device, said finger-like formation upon opening of said at least one actuation device for disassembly of said blade from said handle co-operates with said at least one cut out in said blade and presses said blade in a direction away from said handle to press a part of said blade out of position between said first and second contact surfaces of said fastening device.

60. Saw according to claim 56, wherein said second turning axis is constituted by at least one shaft.

61. Saw according to claim 60, wherein said at least one shaft comprises at least one bolt.

62. Saw according to claim 50, wherein said fastening device has at least one spring, which upon opening of said at least one actuation device in connection with disassembly of said blade in said handle presses said blade in a direction away from said handle.

63. Saw according to claim 62, wherein said at least one spring is integral with said fastening device.

64. Saw according to claim 49, wherein said at least one rotational body comprises at least one stop lip.

65. Saw according to claim 49, wherein said at least one rotational body comprises at least one release bulge.

66. Saw according to claim 49, wherein said handle has at least one first gripping part having a substantial direction of extension that forms an angle of 5-20° in relation to a substantial plane of extension of said blade (1).

67. Saw according to claim 49, wherein said first turning axis extends substantially perpendicular to the plane of extension of the blade.

68. Handle for use in a saw having a detachable blade, the handle having at least one fastening device with at least one first part in the form of a rotational body, which rotational body can be turned around a first turning axis, said rotational body being adapted to co-operate with a cut out in the blade, said rotational body being able to be turned at least about 90° around said first turning axis, a second part of said fastening device being in the form of an insert movable in relation to said handle at assembly and/or disassembly of said blade relative to said handle, said second part being movable around and/or in relation to said first turning axis in a first end of said second part and around and/or in relation to a second turning axis in a second end of said second part.

69. Handle according to claim 68, wherein said rotational body can be turned at least about 180° around said first turning axis.

70. Handle according to claim 68, wherein said at least one rotational body is connected with and operated by at least one actuation device of said fastening device.

71. Handle according to claim 70, wherein said actuation device is in the form of an elongate arm that connects to the rotational body in one end of the elongate arm.

72. Handle according to claim 68, wherein the second turning axis is in the form of at least one shaft, said first and second turning axes being substantially parallel.

73. Handle according to claim 68, wherein said second part of said fastening device alone comprises at least one first contact surface adapted for abutment against a first side of the blade, at least one second contact surface adopted for abutment against a second side of the blade, and at least one third contact surface that abuts against at least one groove adapted therefor in at least one additional part of said fastening device or in the handle, said first and second contact surfaces being adapted to retain and stabilize the blade in the handle.

74. Handle according to claim 68, wherein said second part of said fastening device comprises at least one first contact surface adapted to abut against a first side of the blade, and a third part of said fastening device in the form of a second insert comprises at least one second contact surface adapted to abut against a second side of the blade, said first and second contact surfaces being adapted to retain and stabilize the blade in the handle.

75. Handle according to claim 73, wherein said insert is movable in relation to the handle at assembly and/or disassembly of the blade relative to the handle with the purpose of facilitating such assembly and/or the disassembly.

76. Handle according to claim 74, wherein said first and second inserts are movable in relation to the handle at assembly and/or disassembly of the blade relative to the handle for facilitating such assembly and/or the disassembly.

77. Handle according to claim 71, wherein said at least one rotational body comprises at least one finger-like formation, which upon closure of said at least one actuation device during fitting of the blade in the handle is adapted to co-operate with the at least one cut out in the blade to pull the blade in a direction toward the handle to pull in a part of the blade in place between said first and second contact surfaces of said fastening device, said finger-like formation upon opening of said at least one actuation device during disassembly of said blade from the handle is adapted to co-operate with the at least one cut out in said blade and press said blade in a direction away from the handle to press a part of said blade out of the position between said first and second contact surfaces of said fastening device.

78. Handle according to claim 68, wherein said at least one shaft comprises at least one bolt.

79. Handle according to claim 68, wherein said fastening device includes at least one spring, which upon opening of said at least one actuation device during disassembly of said blade from the handle presses said blade in a direction away from the handle.

80. Handle according to claim 79, wherein said at least one spring is integral with said fastening device.

81. Handle according to claim 68, wherein said at least one rotational body comprises at least one stop lip.

82. Handle according to claim 68, wherein said at least one rotational body comprises at least one release bulge.

83. Handle according to claim 68, comprising at least one first gripping part having a substantial direction of extension direction adapted to form an angle of 5-20° in relation to a plane of extension of said blade when fitted in the handle.

84. Blade for use in a saw and adapted for removal from a handle of the saw, the blade having at least one through cut out extending from an edge of the blade said at least one cut out including at least one first recess having substantially parallel sides and adapted to co-operate with a rotational body of the handle for pulling the blade closer to the handle when being locked in the handle.

85. Blade according to claim 84, wherein said at least one cut out has at least one second recess with substantially parallel sides.

86. Blade according to claim 85, wherein said at least one cut out has at least one third recess with substantially parallel sides.

87. Blade according to claim 84 having at least one side spring tongue arranged to spring in a direction substantially perpendicular to a plane of extension of the blade.

88. Blade according to claim 87, wherein said side spring tongue has a direction of extension substantially in the plane of extension of the blade that differs from a substantial direction of extension of said first recess by an angle no greater than about 45°.

89. Blade according to claim 84, wherein said at least one cut out is unsymmetrical in a substantial plane of extension of the blade and situated in a first end of the blade.

90. Blade according to claim 86, wherein said first recess is positioned closest to a first long side of the blade, said second recess is positioned closest to a second long side of the blade, and said third recess is positioned between said first recess and said second recess.

91. Blade according to claim 87, wherein said at least one cut out includes first, second and third recesses each with substantially parallel sides, said side spring tongue being situated between said first recess and said third recess of the blade.

92. Blade according to claim 88, wherein said angle is no greater than about 22.5°.

93. Blade according to claim 88, wherein said angle is about 10°.

94. Saw according to claim 49, wherein said at least one cut-out is arranged to enable the blade to be inverted in the handle.

95. Saw according to claim 49, wherein said at least one cut-out is symmetrical with respect to a straight line parallel to a toothed edge of the blade wherein said blade is fittable in two different ways in the handle, the blade forming a first angle with the handle in a substantial plane of extension of the saw when fitted in the first way for sawing substantially downwards, the blade forming a second angle with the handle in the substantial plane of extension of the saw when fitted in the second way for sawing substantially upwards, said first and second angles being of substantially equal size.

96. Saw according to claim 49, wherein said at least one cut-out is symmetrical with respect to a straight line non-parallel to a toothed edge of the blade wherein said blade is fittable in two different ways in the handle, the blade forming a first angle with the handle in a substantial plane of extension of the saw when fitted in the first way for sawing substantially downwards, the blade forming a second angle with the handle in the substantial plane of extension of the saw when fitted in the second way for sawing substantially upwards, said first and second angles being of unequal size.
